(19) United States
(12) Patent Application Publication
(10) Pub. No.: US 2004/0179864 A1
(43) Pub. Date: Sep. 16, 2004

(54) Method and apparatus for forming image

(75) Inventor: Sadahiro Masuda, Mishima-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/387,385

(22) Filed: Mar. 14, 2003

(51) Int. Cl. G03G 15/01

(52) U.S. Cl. 399/226

(57) ABSTRACT

The present invention retreats all developing units of a color developing apparatus to a retracted position where the units are not rotated around the axis of rotation to develop a Bk latent image by color toner, while a Bk image is being developed, and retracts the units to a position wherein a photoconductive drum can be located to be opposite to a predetermined color developing unit in the shortest time, when color image formation is instructed.

### BACKGROUND OF THE INVENTION

The present invention relates to an electrophotographic image forming apparatus which forms a color image on an image output medium according to subtractive primaries, for example.

The image forming apparatus which forms a color image according to subtractive primaries, includes a black (Bk) developing unit for outputting a single black Bk (Black), and color developing units for outputting three single colors of C (Cyan), M (Magenta) and Y (Yellow) composing a color image.

Nowadays, there is proposed an image forming apparatus in which a Bk developing unit is independently provided, and three color developing units of C, M and Y are constructed in one body, to reduce the size of an image forming apparatus. As one of the methods of constructing three color developing units of C, M and Y, a revoler system has been put to practical use, in which while one optical color image developing unit is located at the position opposite to a photoconductor, another color developing unit is retracted around a single shaft.

For example, Jpn. Pat. KOKAI Publication No. 9-197812 discloses an example, in which three color developing units of C, M and Y are constructed as one body of the revoler system, and a Bk developing unit is independently provided.

Jpn. Pat. KOKAI Publication No. 2001-56593 discloses another example, in which a Bk developing unit is independently provided, and four color developing units of C, M, Y and Bk are further constructed in one body of the revoler system.

Either patent application mentioned above indicates that when a Bk image is formed by a Bk developing unit, the other developing units of the revoler system are retracted from the developing position opposite to a photoconductor.

However, neither patent application discloses a method of setting a developing unit at a developing position when forming a color image by using the developing units of the revoler system retracted from a developing position, and/or a configuration for positioning a specific color developing unit (of the revoler) at a developing position.

Further, there is a problem peculiar to when forming a color image by using the developing units of the revoler system; the number of image forming times (the number of output images) per a unit time is decreased depending on the relationship between the moving (the revoler turning) direction when moving a retracted developing unit to the optional color developing position and/or the color locatable at the developing position (the position of each developing unit), and the image data (color) developed to be able to output fastest among the image data for each color.

### BRIEF SUMMARY OF THE INVENTION

It is an object of the present invention is to improve the number of image forming times per a unit time in an image forming apparatus which forms a color image on an image output medium according to subtractive primaries.

The present invention provides an image forming apparatus comprising:

a photoconductor which holds a latent image;

a first developing unit which develops the latent image formed on the photoconductor by supplying a first color developer;

a second developing unit which develops the latent image formed on the photoconductor by supplying a second color developer different from the first color developer;

a first developing unit retracting mechanism which moves the first developing unit to the position where the first color developer is not adhered to the latent image on the photoconductor, when the second developing unit is instructed to develop the latent image formed on the photoconductor;

a second developing unit retracting mechanism which rotates the second developing unit by a predetermined angle around the axis of rotation of the second developing unit to the state that the second color developer is not adhered to the latent image on the photoconductor, when the first developing unit is instructed to develop the latent image formed on the photoconductor; and

a second developing unit position detection mechanism which can stop the rotation of the second developing unit in the state that the second color developer is not adhered to the latent image on the photoconductor, when the second developing unit is rotated around the axis of rotation.

The present invention provides an image forming apparatus comprising:

a photoconductor which holds a latent image;

a black developing unit which develops the latent image formed on the photoconductor by supplying a black developer;

a color developing unit which includes three developing units containing three color toner of C (Cyan), M (Magenta) and Y (Yellow) for forming a color image according to subtractive primaries, and forms a non-black image by supplying at least one color toner out of C, M and Y to the latent image formed on the photoconductor; and

a color developing unit retracting mechanism which rotates the color developing unit by a predetermined angle around the axis of rotation of the color developing unit, so that none of C, M and Y color toner is adhered to the latent image on the photoconductor, when the black toner is specified to develop the latent image formed on the photoconductor.

Further, the present invention provides a method of controlling the positions of developing units which include a first developing unit for developing an achromatic color image, and a second developing unit for developing a chromatic color image, and develops an image formed on a photoconductor by one of the first and second developing unit, comprising:

receiving an instruction to develop a latent image formed on a photoconductor by the first or second developing unit; and

stopping one of the developing units at the position where its own developing roller is not located to be opposite to the developing position capable of developing the latent image on the photoconductor by being located to be opposite to the photoconductor,

by rotating in a predetermined direction the second developing unit which includes an axis acting as a center of rotation, and has three developing units containing three color toner of C, M and Y, the each developing unit is formed rotatable around the axis of rotation, when the instruction is development by the first developing unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic illustration explaining an example of a digital copier, to which the present invention is applied;

FIG. 2 is a block diagram explaining an example of the signal processing system and/or control system of the copier shown in FIG. 1;

FIG. 3 is a schematic illustration explaining an example of the positional relationship between a developing unit and a photoconductor, which are incorporated in the copier shown in FIG. 1;

FIG. 4 is a schematic illustration explaining an example of the operation (forming a color image) of the developing unit shown in FIG. 3;

FIG. 5 is a schematic illustration explaining an example of the operation (forming a Bk image) of the developing unit shown in FIG. 3;

FIG. 6 is a schematic illustration explaining an example of the stop position of a color developing unit when forming the Bk image shown in FIG. 5;

FIG. 7 is a schematic illustration explaining an example of the relationship between the stop position and home position of the color developing unit shown in FIG. 6; and

FIG. 8 is a schematic illustration explaining an example of the relationship between the home position and developing position of the color developing unit shown in FIG. 6.

### DETAILED DESCRIPTION OF THE INVENTION

Hereinafter, an example of image forming apparatus to which the present invention is applicable, taking an example of a digital copier, with be explained with reference to the accompanied drawings.

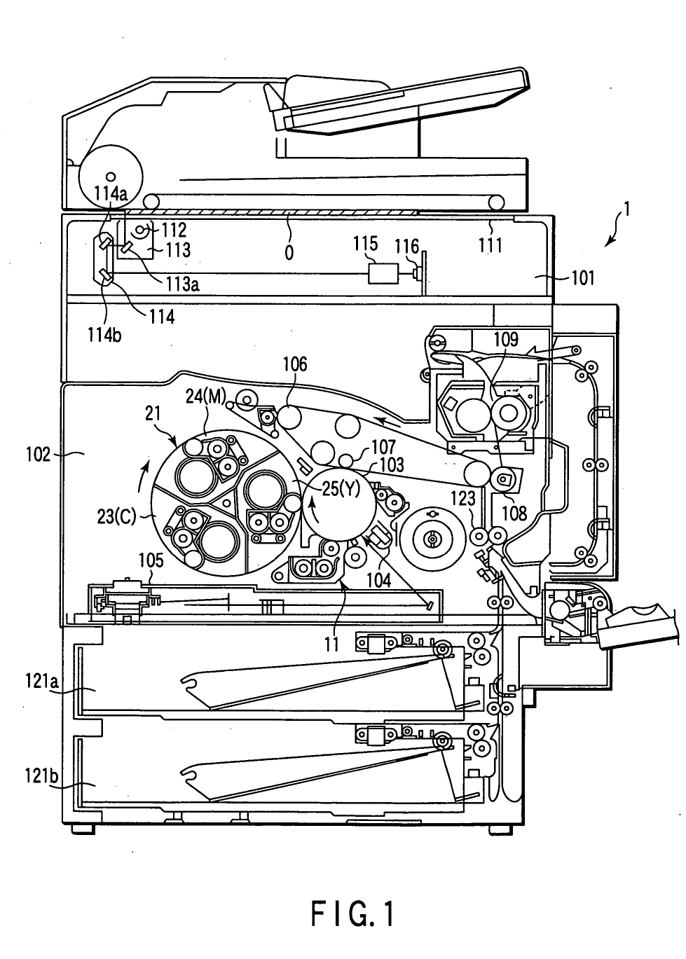

As shown in FIG. 1, a color digital copier 1 includes a scanner (color image reader) 101 which reads the image information held by a copying object O as brightness and darkness of light, and generates an image signal, and an image forming unit (MFP=Multi Functional Pedestal) 102 which forms an image corresponding to the image signal supplied from the scanner 101 or an external unit.

In the copier 1 shown in FIG. 1, when copying the image information of a reading object O, the reading object O is placed at a predetermined position on a document table 111.

A copy start instruction is given from a not-shown operation panel, and an illumination lamp 112 lights to provide an illumination light with a predetermined intensity.

First and second carriages 113 and 114 move along the document table 111 at a predetermined speed corresponding to a copying magnification, and the illumination lamp 112 sequentially illuminates the image information of the reading object O set on the document table 111.

The illumination light is reflected from the reading object O, including the image information as brightness and darkness of light. Hereinafter, this reflected light is called an image light.

The image light is reflected from an image pickup mirror 113a fixed to the first carriage 113, toward the second carriage 114, and further reflected on a first mirror 114a and second mirror 114b of the second carriage 114, and is applied to an image forming lens 115.

The image light applied to the image forming lens 115 is transmitted to the light receiving surface of a CCD sensor 116, and the image is formed thereon.

After the image is formed in the CCD sensor 116, the image light is sequentially opto-electrically converted by three line sensors corresponding to R (Red), G (Green) and B (Blue) images, that are the complementary colors of C, M and Y, respectively (or by four line sensors of R, G, B and Bk), and output at a predetermined timing.

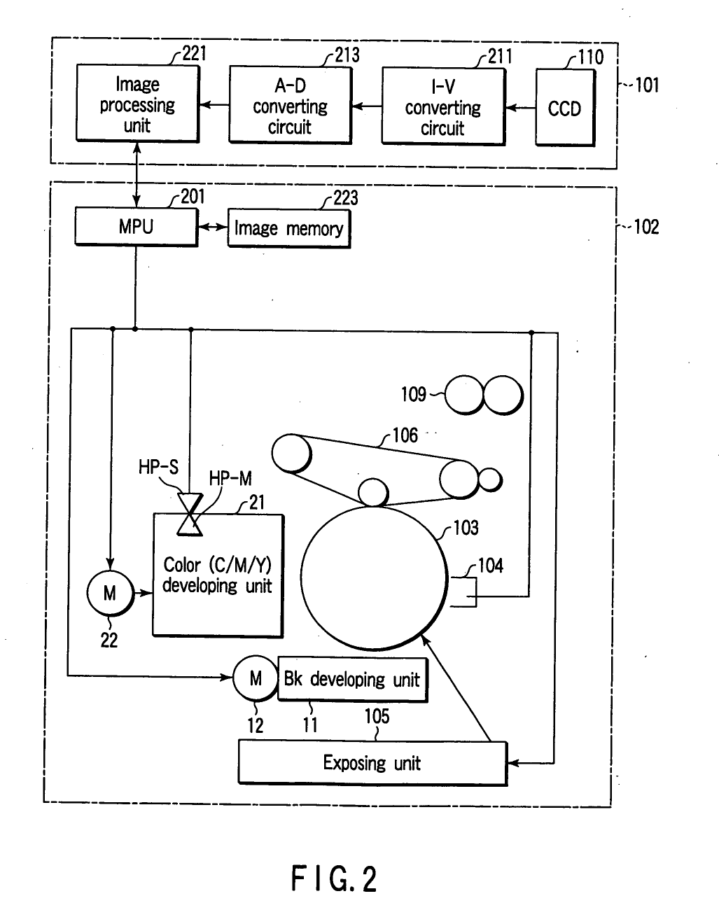

The opto-electrically converted output from the CCD sensor 116, or the image signal, is amplified to a predetermined level by an amplifier (I/V converter) 211 to be explaining later with reference to FIG. 2, converted to a digital signal by an A/D converter 213, and output line by line to an image processor 221.

The image data applied to the image processor 221 is processed according to a predetermined routine in the image processor 221, and stored in a predetermined memory area (e.g., an image memory 223) in an image forming apparatus 102.

The amplifier 211, A/D converter 213 and image processor 221 shown in FIG. 2 are controlled by a main control unit (MPU=Main Processing Unit) 201. Of course, the independent units such as a charger 104, an exposing unit 105 and a fixing unit 106, and motors used in a developing unit to be explained later are also operated under the control of the MPU 201.

Next, the exposure unit 105 radiates the exposure light, which is modulated in intensity based on the image data read by the scanner 101 and stored in the image memory 223, at a predetermined position on a photoconductive drum 103, thereby forming a latent image corresponding to the exposure light intensity on the photoconductive drum 103.

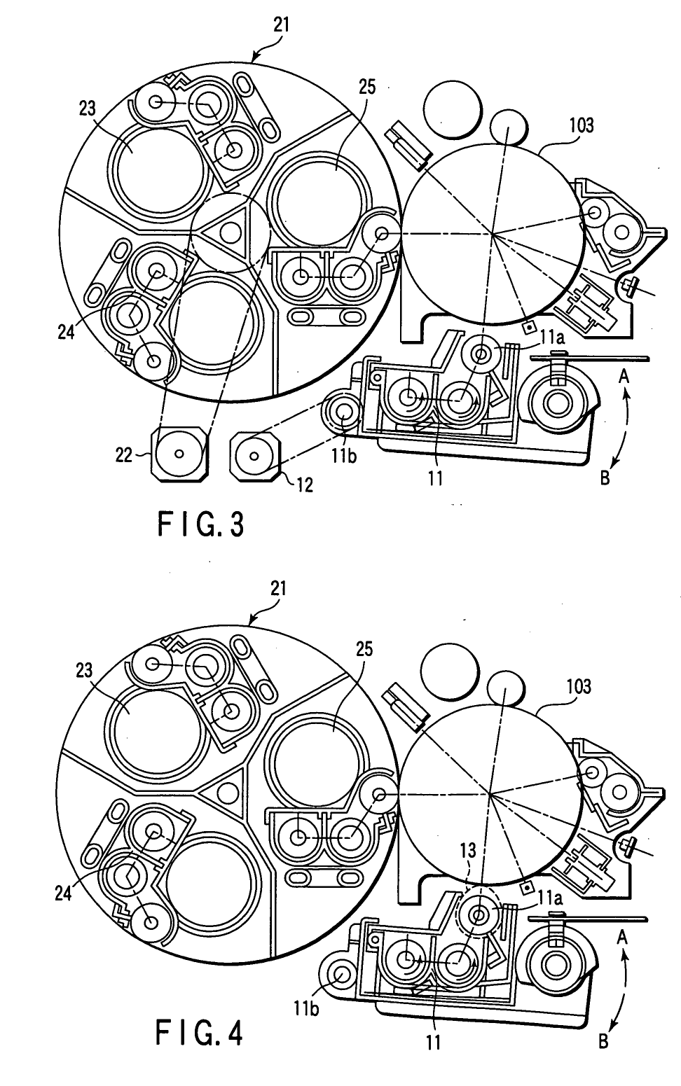

The latent image formed on the photoconductive drum 103 is made visible (developed) as a toner image by being selectively supplied with the toner of the corresponding colors from a black (Bk) developing unit 11 for developing a single black or a Bk image, or color developing units for developing three single colors of C (Cyan), M (Magenta) and Y (Yellow) composing a color image, which are to be explained later with reference to FIG. 3.

The toner image formed on the photoconductive drum 103 is carried by rotation of the photoconductive drum 103 to an intermediate transfer position where a transfer belt (intermediate transfer body) 106 is opposite to the photoconductive drum 103.

The toner image on the photoconductive drum 103 carried to the intermediate transfer position is transferred to the transfer belt 106 by the intermediate transfer voltage supplied from an intermediate transfer unit 107.

The toner image transferred to the transfer belt 106 is carried to the area, where the transfer unit 108 is opposite to the transfer belt 106 and outputs a predetermined transfer voltage to transfer the toner image to paper P, which is taken out at a predetermined timing from a cassette 121a or 12ab, matched the timing with the toner image position on the photoconductive drum 103 by an aligning roller 123, and carried to the transferring position. Further, the paper P can be replaced by colored paper or a transparent resign sheet, for example, according to the user's demand.

The paper P transferred with the toner image is carried to a fixing unit 109, and supplied with predetermined heat, whereby the toner composing the toner image is fused and fixed to the paper P.

Next, explanation will be given on an example of the operation of the developing unit in the case when the latent image formed on the photoconductive drum corresponds to each color component based on subtractive primaries.

The latent image formed corresponding to the image data separated according to subtractive primaries is as well known, developed by the toner colored to the corresponding colors as an image of three single colors of C, M and Y. Of course, a Bk developing unit is used to emphasize the contrast of a color image and to develop a Bk image independently.

When image formation using a color developing unit 21 is instructed, the Bk developing unit 11 is moved to the Bk retracted (color developing) position where the photoconductive drum 103 does not come in contact with a developing roller 11a, as shown in FIG. 3. Further, at the color developing (Bk retracted) position, the Bk developing unit 11 moves to the position securing a distance to the surface of the photoconductive drum 103, between the photoconductive drum 103 and developing roller 11a, where the toner of the developing roller 11a is not electrostatically adhered to the latent image formed on the photoconductive drum 103.

For example, by fixing the developing unit 11 to the shaft 11b which is rotated by the driving force supplied from a motor 12, the developing unit 11 can be moved in the direction approaching the photoconductive drum 103 (indicated by the arrow A) or in the direction separating from the photoconductive drum 103. (indicated by the arrow B).

Conversely, as shown in FIG. 4, by supporting the developing unit 11 by the shaft 11b so that the unit is rotatable around the shaft, and by rotating a cam mechanism 13 provided coaxially with the developing roller 11a by the driving force from a not-shown cam motor, the developing unit 11 can be moved in the direction approaching the photoconductive drum 103 (indicated by the arrow A) or in the direction separating from the photoconductive drum 103 (indicated by the arrow B).

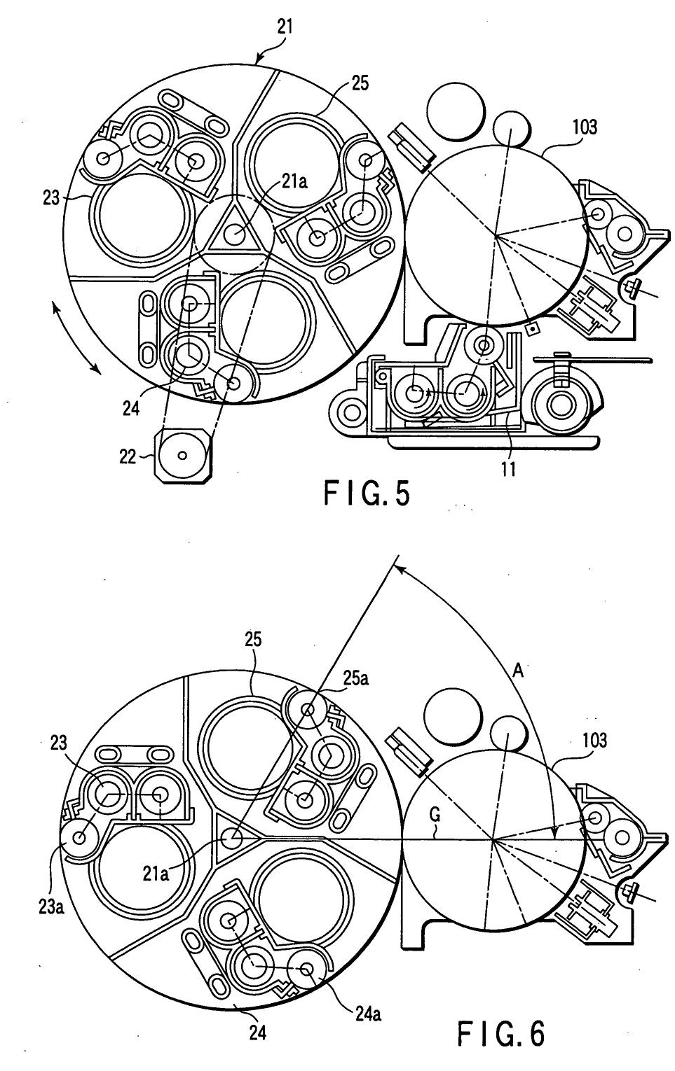

Contrarily, when image formation of a single color Bk is instructed, the developing unit 11 is located at the Bk developing position where the developing roller 11a of the Bk developing unit 11 comes in contact with or becomes to be opposite to the photoconductive drum 103 with a little clearance, as shown in FIG. 5. In this case, the color developing unit 21 is rotated by a predetermined angle in an optional direction centering around the shaft 21a by the force transmitted by the rotation of the motor 22, for example, and located at the Bk developing (color retracted) position, as shown in FIG. 5.

The Bk developing position is the position where the toner is not electrostatically adhered to the latent image formed on the photoconductive drum 103, and all rollers of a C-developing unit 23, an M-developing unit 24 and a Y-developing unit 25 arranged around the shaft 21a of the color developing unit 21, are not positioned to be opposite to the photoconductive drum 103. The developing rollers 23a, 24a, 25a of the color developing unit 21 and the photoconductive drum 103 at the Bk developing position or the color retracted position, are defined when the developing unit including the developing roller opposite to the photoconductive drum 103 is rotated in the counterclockwise direction by the angle indicated by A centering around the shaft 21a, from the segment G connecting the photoconductive drum 103 and the shaft 21a of the color developing unit 21, for example, as shown in FIG. 6. The angle A can be set in an optional range of 5 to 85°, preferably 15 to 60°.

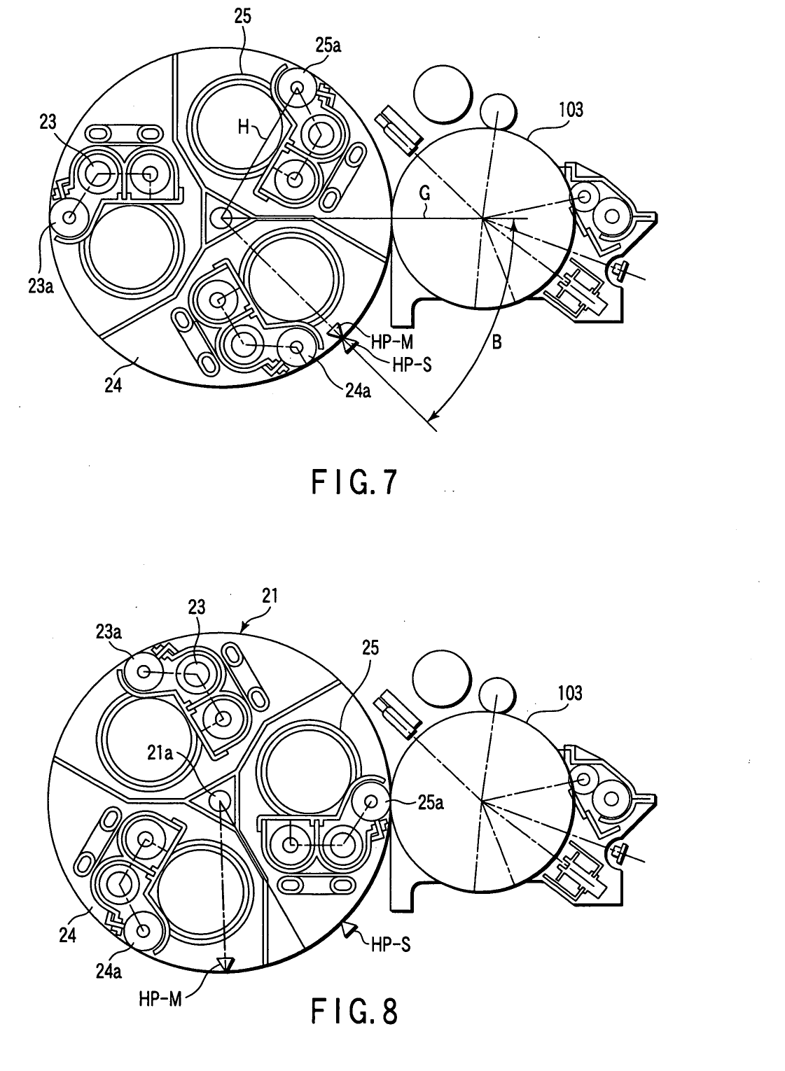

At a predetermined position in the color developing unit 21, a home position marker HP-M is provided to inform the position of the developing unit opposite to or opposable to the photoconductive drum 103 in the state that the color developing unit 21 is rotating around the shaft 21a, that is, the position in the developing unit to develop the latent image of each color, as shown in FIG. 7.

The position of the position marker HP-M is detected by a home position sensor HP-S provided at a predetermined position in the circumference of the color developing unit 21.

Therefore, when the home position sensor HP-M in the color developing unit 21 is detected by the home position sensor HP-S, it is also detected that the color developing unit 21 is located at the home position by the MPU 201, explained above with reference to FIG. 2, and the Bk image can be developed by the Bk developing unit 11.

The home position sensor HP-S can be provided at an optional position on the circumference of the developing unit 21, as long as the developing rollers (23a, 24a and 25a) of the developing unit, which develops the latent image of each color rotating around the shaft 21a, cannot develop the latent image formed on the photoconductive drum 103, that is, the developing roller can be located in the range of angle A explained in FIG. 6. The home position marker HP-M and optional developing roller (23a, 24a and 25a) are set, so that the developing unit of the first developed color can be located to be opposite to the photoconductive drum 103 in the shortest time, when developing a color image, for example.

For example, when the developing unit to be used first for forming a color image by the color developing unit 21 is the Y developing unit 25, the position marker HP-M is located at the position of 100° in the clockwise direction from the segment H connecting the developing roller 25 and shaft 21. Therefore, the home position sensor HP-S is located at the position rotated by the angle indicated by B in the counterclockwise direction from the segment G connecting the photoconductive drum 103 and the shaft 32a of the developing unit 21. The angle B in the example shown in FIG. 7 is 40°.

By arranging the home position marker HP-M and home position sensor HP-S at the above-mentioned positions, when the color developing unit 21 is rotated by the retracted operation for developing Bk and stopped at the home position HP, the developing roller 25a of the Y developing unit 25 used first for developing a color image is stopped at the position of 60° in the counterclockwise direction from the segment G connecting the photoconductive drum 103 and the developing roller.

Namely, when development of Bk is finished or when development of color image is instructed, the Y developing unit 25 containing the Y-toner or the first color is located to be opposite to the photoconductive drum 103 at the developing position, by rotating the color developing unit 21 only by 60° from the home position where the home position sensor HP-S is opposite to the home position marker HP-M, so that the developing roller 25a of the Y developing unit 25 becomes opposite to the photoconductive drum 103.

As explained above, in the digital copier 1 in which the Bk developing unit 11 and color developing unit 21 are independently provided on the circumference of the photoconductive drum 103, when a color image is formed by the color developing unit 21, the Bk developing unit 11 is moved to the position where the Bk toner cannot be supplied to the latent image formed on the photoconductive drum 103; and when a Bk image is formed by the Bk developing unit 11, the developing units 23, 24 and 25 which are assembled as one body as a color developing unit 21, containing three color toner of C, M and Y, are rotated only by a predetermined amount around the rotary shaft 21a and moved to the position where any color toner cannot be supplied to the latent image formed on the photoconductive drum 103; whereby when color image formation is instructed, a color image can be formed by the color developing unit within a short time.

Further, since the developing unit containing the color toner to be used first can be located at the developing position between the photoconductive drum 103 when color image formation is instructed while the color developing unit 21 is being located at the color retracted position, the switching time when the instruction is changed from the Bk image formation to the color image formation, is reduced.

As explained hereinbefore, according to the embodiments of the present invention, the Bk developing unit for developing a Bk image and the color developing unit for developing a color image are not simultaneously located at the developing position capable of developing a latent image formed on the photoconductive drum. Thus, for example, adhesion of color toner can be prevented while a Bk image is being developed. And, Bk toner cannot mix into a color image.

In the Bk image formation using the Bk developing unit, the color developing unit is rotated to the retracted position and set in the retracted state, but when color image formation is instructed, the specified color developing unit is located to be opposite to the photoconductive drum, becoming ready to develop within the shortest time. Namely, the switching time is reduced when the instruction is changed from the Bk image formation to the color image formation is reduced, improving the throughput in outputting an image output.

Though an example of the operation of the developing unit has been explained taking an MPF as an example to explain the above-mentioned embodiment, it is of course possible to use a page printer (color printer), a facsimile, and so on.

The present invention is not to be restricted to the above-mentioned embodiments, and various modifications and improvements are possible in embodying the invention without departing from the essential characteristics. Each embodiment can be combined as far as possible, and in that case, the effect of the combination can be obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a photoconductor which holds a latent image;
a first developing unit which develops the latent image formed on the photoconductor by supplying a first color developer;
a second developing unit which develops the latent image formed on the photoconductor by supplying a second color developer different from the first color developer;
a first developing unit escaping mechanism which moves the first developing unit to the position where the first color developer is not adhered to the latent image on the photoconductor, when the second developing unit is instructed to develop the latent image formed on the photoconductor;
a second developing unit retracting mechanism which rotates the second developing unit by a predetermined angle around the axis of rotation of the second developing unit to the state that the second color developer is not adhered to the latent image on the photoconductor, when the first developing unit is instructed to develop the latent image formed on the photoconductor; and
a second developing unit position detection mechanism which can stop the rotation of the second developing unit in the state that the second color developer is not adhered to the latent image on the photoconductor, when the second developing unit is rotated around the axis of rotation.

2. An image forming apparatus according to claim 1, wherein the second developing unit includes an independently operable developing unit which contains at least a second color developer and a third color developer different from the first color developer contained in the first developing unit.

3. An image forming apparatus according to claim 1, wherein the first developing unit is used when the latent image is an achromatic color image.

4. An image forming apparatus according to claim 2, wherein the second developing unit includes a marker which is related to the position of an optional developing unit of the independently operable developing unit, and can inform the second developing unit position detection mechanism of the current position of the optional developing unit rotating around the axis of rotation.

5. An image forming apparatus according to claim 4, wherein the second developing unit position detection mechanism is provided to be able to locate the optional developing unit informed by the marker to the position locatable to the developing position defined between the photoconductor, within a predetermined time, when image formation by the second developing unit is instructed.

6. An image forming apparatus according to claim 4, wherein the second developing unit includes three single color developer of C (Cyan), M (Magenta) and Y (Yellow) to form a color image according to subtractive primaries, each of the single color developing unit arranged rotatable optionally around the axis of rotation.

7. An image forming apparatus according to claim 6, wherein the second developing unit position detection mechanism is located to be cable to locate the optional developing unit informed by the marker to the position locatable to the developing position defined between the photoconductor within a predetermined time, in the shortest time, when image formation by the second developing unit is instructed.

8. An image forming apparatus according to claim 6, wherein the marker of the second developing unit is provided to be able to locate the position of the developing unit to be located first to the developing position among the three developing units, close to the developing position, when color image formation is instructed.

9. An image forming apparatus according to claim 1, further comprising an intermediate transfer body which carries a developer image obtained by developing the latent image formed on the photoconductor to the transfer position to transfer to a material to be transferred.

10. An image forming apparatus comprising:
a photoconductor which holds a latent image;
a black developing unit which develops the latent image formed on the photoconductor by supplying a black developer;
a color developing unit which includes three developing units containing three color toner of C (Cyan), M (Magenta) and Y (Yellow) for forming a color image according to subtractive primaries, and forms a non-black image by supplying at least one color toner out of C, M and Y to the latent image formed on the photoconductor; and
a color developing unit retracting mechanism which rotates the color developing unit by a predetermined angle around the axis of rotation of the color developing unit, so that none of the C, M and Y color toner is adhered to the latent image on the photoconductor, when the black toner is specified to develop the latent image formed on the photoconductor.

11. An image forming apparatus according to claim 10, further comprising a mechanism which detects the position of the developing unit containing an optional color toner of the color developing unit, and can stop the rotation of the color developing unit in the state
that none of C, M and Y color toner is adhered to the latent image on the photoconductor, when the color developing unit is rotated around the axis of rotation.

12. An image forming apparatus according to claim 11, wherein the color developing unit includes a marker which is related to the position of an optional developing unit out of the three developing units of C, M and Y, and can inform the position detection mechanism of the current position of the optional developing unit rotating around the axis of rotation.

13. The image forming apparatus according to claim 12, wherein the position detection mechanism is located to be able to locate the optional developing unit informed by the marker to the position locatable to the developing position defined between the photoconductor within a predetermined time, in the shortest time, when image formation by the color developing unit is instructed.

14. A method of controlling the position of a developing unit which includes a first developing unit for developing an achromatic color image, and a second developing unit for developing a chromatic color image, and develops an image formed on a photoconductor by one of the first and second developing unit, comprising:
receiving an instruction to develop a latent image formed on a photoconductor by the first or second developing unit; and
stopping one of the developing units at the position where its own developing roller is not opposite to the developing position capable of developing the latent image on the photoconductor by being located to be opposite to the photoconductor, by rotating in a predetermined direction the second developing unit which includes an axis acting as a center of rotation, and has three developing units containing three color toner of C, M and Y, said each developing unit is formed rotatable around the axis of rotation, when the instruction is development by the first developing unit.

15. An method of controlling the developing unit position according to claim 14, wherein the second developing unit is related to the position of an optional developing unit among the three developing units of C, M and Y, includes a marker which can inform the position detection mechanism of the current position of the optional developing unit rotating around the axis of rotation, and stops the optional developing unit informed by the marker in the state that the developing rollers of each developing unit are not opposite, by a position detection mechanism which can locate the optional developing unit to the developing position capable of developing the latent image within a predetermined time, in the shortest time, when image formation by the second developing unit is instructed.
